(19) United States
(12) Patent Application Publication
(10) Pub. No.: US 2008/0154638 A1
(43) Pub. Date: Jun. 26, 2008

(54) METHOD AND SYSTEM FOR PROVIDING CROSS-SYSTEMS SERVICES TO DEVELOPMENTALLY DISABLED YOUTH

(76) Inventors: Carl M. Coyle, Fayetteville, NY (US); L. Robert Ciota, Camillus, NY (US)

Correspondence Address: MARJAMA MULDOON BLASIAK & SULLIVAN LLP, 250 SOUTH CLINTON STREET, SUITE 300, SYRACUSE, NY, 13202, US

(21) Appl. No.: 11/958,580

(22) Filed: Dec. 18, 2007

Related U.S. Application Data
(60) Provisional application No. 60/876,943, filed on Dec. 22, 2006.

(51) Int. Cl. G06Q 50/00

(52) U.S. Cl. 705/2

(57) ABSTRACT

A method and a system are provided for providing family services and systems of care to developmentally disabled individuals with co-occurring disorders including mental health diagnosis and traumatic brain injury. Also provided are a method and a system for providing highly integrated, multi-systems (“cross-systems”) services to high-need developmentally disabled adolescents who manifest significant behavior management needs. Further provided are a method and a system for providing cross-systems services to the primary family caregivers of high-need developmentally disabled adolescents.

### CROSS-REFERENCE TO RELATED APPLICATIONS

This application claims priority to and the benefit of co-pending U.S. provisional patent application Ser. No. 60/876,943 entitled “Method and System for Providing Cross-Systems Services to Developmentally Disabled Youth,” filed Dec. 22, 2006, which is incorporated herein by reference in its entirety.

### 1. TECHNICAL FIELD

The present invention relates to methods for providing family services and systems of care to developmentally disabled individuals with disorders such as mental health diagnosis or traumatic brain injury. The invention further relates to methods for providing family services and systems of care to developmentally disabled individuals who are diagnosed with multiple disorders.

### 2. BACKGROUND OF THE INVENTION

High-need developmentally disabled adolescents, who manifest significant behavior management needs, represent a significant challenge to the education, mental health, child welfare, and juvenile justice and developmental disability systems. These “cross-system youth” have not been adequately served by any system and represent a significant challenge at home, in school, and other community settings. The barriers of categorical funding, auspice and diagnostic categorization virtually assure that no single system can meet the multiplicity of their complex needs. When viewed in the context of the family system attempting to maintain the child in the home or community, the lack of true systems integration becomes insurmountable. These “cross-system” youth are not adequately served, since no single system can meet their complex needs.

The presence of a developmental disability in combination with a multitude of other individual and family needs results in service requirements that often exceed the resource capacity of any one system. The presence of difficult-to-manage behaviors often results in the youth's exclusion from regular school attendance and puts the youth at high risk for family court and probation involvement, placement outside the home, higher utilization of community emergency psychiatric services, and inappropriate use of or over reliance on mental health and juvenile justice services and/or systems of secure settings controlled by, e.g., state or regional offices that focus on issues of mental retardation or developmental disabilities in individuals.

There is therefore a need in the art for programs that provide assistance to developmentally disabled children and adolescents and to their primary caregivers, while promoting appropriate access and utilization of public services and systems of care. Reducing reliance on inappropriate systems of care would result in reduced costs to those systems.

There is also a need in the art for a system of providing services for children or adolescents with cross-systems needs who require cross-system services. There is further a need for a system for providing a network of services to children who are diagnosed with two or more behavior management needs.

There is also a need in the art for methods for increasing permanency and stability for cross-systems youth and their family within their natural support systems, e.g., home, school, and community, for increasing the safety of cross-systems youth and others, decreasing the number and frequency of crisis episodes resulting in emergency placement outside of the home, and improving the capacity of primary caregivers to care for cross-systems youth.

Citation or identification of any reference in Section 2, or in any other section of this application, shall not be considered an admission that such reference is available as prior art to the present invention.

### 3. SUMMARY OF THE INVENTION

Methods and systems are provided for providing cross-systems services to an individual in need of cross-systems services. In one embodiment, the individual is a developmentally disabled youth.

A system is provided for providing cross-systems services to an individual in need of cross-systems services comprising:

a. a list of eligibility or admissions criteria, wherein the eligibility or admissions criteria are criteria concerning a need for cross-systems services;

b. a list of attributes by which an eligible individual in need of cross-systems services is evaluated;

c. an evaluation of the individual;

d. a cross-systems services coordinator or coordination team; and

e. a plan for cross-systems services (“plan for services,” “service plan”).

In one embodiment, the plan for cross-systems services is coordinated by the cross-systems services coordinator or coordination team.

In another embodiment, the plan for cross-systems services is based on the evaluation.

In another embodiment, the individual is a developmentally disabled adolescent.

In another embodiment, the cross-systems services are selected from the group consisting of: intake services, evaluation and assessment services, family-centered planning for services, psycho-educational training and skill development, parent-to-parent support, individual and family therapy, habilitation, family reimbursement, transportation services, crisis stabilization, individualized residential alternative (IRA) residential habilitation or community residential habilitation, respite services, transition services, youth psychiatry services, therapeutic family care or foster care, mental health services, services coordination, succession services, discharge or step-down services, prioritized admission, and wrap-around services.

In another embodiment, the plan for cross-systems services comprises a service package.

In another embodiment, the service package comprises a plurality of services. In another embodiment, the plurality of services is selected from the group consisting of: intake services, evaluation and assessment services, family-centered planning for services, psycho-educational training and skill development, parent-to-parent support, individual and family therapy, habilitation, family reimbursement, transportation services, crisis stabilization, individualized residential alternative (IRA) residential habilitation or community residential habilitation, respite services, transition services, youth psychiatry services, therapeutic family care or foster care, mental health services, services coordination, succession services, discharge or step-down services, prioritized admission, and wrap-around services.

A method is also provided for providing cross-systems services to an individual in need of cross-systems services comprising the steps of:

a. Screening one or more potential candidates for eligibility or admissions criteria to determine eligibility for cross-systems services;

b. Identifying an eligible individual in need of cross-systems services for admission to cross-systems services by the screening;

c. Admitting the eligible individual;

d. Evaluating the eligible individual; and

e. Providing cross-systems services to the eligible individual.

In one embodiment, the eligible individual is a developmentally disabled adolescent.

In another embodiment, the eligible individual is a family member or primary caregiver of a developmentally disabled adolescent.

In another embodiment, the step of providing cross-systems services comprises preparing a plan for providing cross-systems services.

In another embodiment, the step of providing cross-systems services comprises providing a cross-systems services coordinator or coordination team.

In another embodiment, the method additionally comprises the step of preparing a plan for cross-systems services.

In another embodiment, the preparation of the plan for cross-systems services is coordinated by the cross-systems services coordinator or coordination team.

In another embodiment, the cross-systems services are selected from the group consisting of: intake services, evaluation and assessment services, family-centered planning for services, psycho-educational training and skill development, parent-to-parent support, individual and family therapy, habilitation, family reimbursement, transportation services, crisis stabilization, individualized residential alternative (IRA) residential habilitation or community residential habilitation, respite services, transition services, youth psychiatry services, therapeutic family care or foster care, mental health services, services coordination, succession services, discharge or step-down services, prioritized admission, and wrap-around services.

In another embodiment, the plan for cross-systems services comprises a service package.

In another embodiment, the service package comprises a plurality of services. In another embodiment, the plurality of services is selected from the group consisting of: intake services, evaluation and assessment services, family-centered planning for services, psycho-educational training and skill development, parent-to-parent support, individual and family therapy, habilitation, family reimbursement, transportation services, crisis stabilization, individualized residential alternative (IRA) residential habilitation or community residential habilitation, respite services, transition services, youth psychiatry services, therapeutic family care or foster care, mental health services, services coordination, succession services, discharge or step-down services, prioritized admission, and wrap-around services.

### 4. BRIEF DESCRIPTION OF THE DRAWINGS

The present invention is described herein with reference to the accompanying drawing(s), in which similar reference characters denote similar elements throughout the several views. It is to be understood that in some instances, various aspects of the invention may be shown exaggerated or enlarged to facilitate an understanding of the invention.

FIG. 1 is a flow diagram showing an example of an embodiment of the method and the system for providing cross-systems services in accordance with the principles of the present invention. See Section 6.2, Example 2, for details.

### 5. DETAILED DESCRIPTION OF THE INVENTION

Methods and systems are provided for providing family services and systems of care to developmentally disabled individuals. In one embodiment, the individual can have co-occurring disorders including but not limited to mental health diagnosis and traumatic brain injury. Also provided are a method and a system for providing highly integrated, multi-systems (“cross-systems,” “X-systems) services to high-need developmentally disabled adolescents who manifest significant behavior management needs. Further provided are a method and a system for providing cross-systems services to the primary family caregivers of high-need developmentally disabled adolescents.

Currently, cross-system youth are not adequately served and represent a significant challenge to the education, child welfare, and juvenile justice and developmental disability systems. No single system can meet their complex needs. A method and a system are provided for providing a highly integrated, multi-systems (“cross-systems”) approach to ensure that these youth achieve stability, permanency and an improved quality of life. In certain embodiments, a family systems approach can be utilized to improve the adaptive behavior functioning of youth and to strengthen the capacity of the primary family caretakers.

In one embodiment, the method and the system provide a service plan and/or a service package for children with cross-systems needs who require cross-system services. According to this embodiment, the system can provides network of services to children who are dually diagnosed, or who are diagnosed with multiple disorders.

In another embodiment, wrap-around services (Medicaid Service Coordination (MSC), psychological/psychiatric treatment, case management) can be provided to the child's family. Alternatively, in another embodiment, a child can be placed in the least restrictive safe setting that meets the child's needs, for example, as close to home (e.g., the home of a parent, relative or other care-giver) as possible. One advantage of the method and the system provided herein is that by keeping a child at home, or close to home, the work of an individual service provider provided by the invention can be enhanced or expedited. Another advantage is that the youth can be prepared for successful reunification into the community.

In another embodiment, a method is provided for providing cross-systems services comprising screening a potential candidate individual, assessing the individual for services, developing a service package that meets the individual's needs if the individual is deemed eligible for services, and placing the eligible individual in the least restrictive setting that meets the individual's needs within a desired period of time. In one embodiment, the individual can be kept at home, with wrap-around services (Medicaid Service Coordination (MSC), psychological/psychiatric treatment, case management) being provided to the family or primary care-giver.

Also provided is a method for an individual who has been dually diagnosed to be treated in one program, rather than having the individual move from placement to placement or system to system to meet multiple treatment needs. In one embodiment, one or more services can be provided geographically within a given local geographical area, e.g., a town, city, or county. In another embodiment, one or more services can be provided geographically within a given larger geographical area, e.g., a region, state, province or country. In a specific embodiment, specialty services, such as specialty beds, can be provided by a regional- or larger-area specific provider.

The method and the system for providing cross-systems services can be used to support the youth and his/her family to achieve stability, permanency and an improved quality of life within a community-based setting. In one aspect, the method and the system can be family-centered. Services can be highly individualized and responsive to an array of family and individual needs and goals. The method and system can be used, for example, to maximize the capability of each family to care for their youth within the family home and through age-appropriate, inclusive, school- and community-based life activities. In another aspect, flexibility in serving the needs of participants can be strengthened by utilizing an “ecological” approach to services, which takes into account the life activities of the family and youth participants. Thus, the flexibility provided by the method and system can also reduce or eliminate gaps in service delivery.

The provided method is a highly integrated, multi-system approach to serving youth who present significant behavioral challenges. In one aspect, the method and system can capitalize on the expertise and experience of professionals in multiple systems of services. In another aspect, the method and system can utilize best practice and evidence-based interventions. In another aspect, the method and system can incorporate extensive feedback from families and service providers. In another aspect, the method and system can provide portability of services in a variety of settings.

In one embodiment, each family and youth can participate with a cross-systems services coordinator (or services coordination team) in designing a plan for cross-systems services (“plan for service,” “service plan”). The range and depth of available service options and the flexibility built into the method and system can provide a high degree of individualization. Currently, the consumer (participant) and his/her family or primary caregiver is often presented with a one-dimensional choice for services. Choices can be maximized because new service options can be created as a result of the “cross-fertilization” between service-providing systems. The provided method and system can enable the service systems to be tailored to the consumer, rather than tailoring the consumer to the service systems.

For clarity of disclosure, and not by way of limitation, the detailed description of the invention is divided into the subsections set forth below.

5.1. Individuals to be Served

In a preferred embodiment, the individual (“participant”) can be a child or adolescent age 12-18 years.

In another embodiment, the individual can be a child age 0-6 years. In another embodiment, the individual can be a child age 6-12 years. In another embodiment, the individual can be a person age 18 or older (adult).

In another embodiment, the individuals to be served can be developmentally disabled adolescents, e.g., adolescents with mild to moderate developmental disabilities and/or significant behavior management needs.

In another embodiment, the individual can be a plurality of individuals, e.g., an adolescent and one or more family members or primary caregivers.

In another embodiment, the individual can be a candidate selected from a waiting list, e.g., a “New York State Cares” waiting list. In another embodiment, the individual can have an identified need for part-time or full-time (e.g., 24-hour) supervision.

In a specific embodiment, an individual who receive cross-systems services can be a developmentally disabled adolescent.

In another embodiment, the individual and the individual's family or primary caregiver can be participants and receive one or more cross-systems services.

In one embodiment, individuals (participants) can be youth who are currently living at home with their families, relatives or caregivers and have identified need(s) that require around-the clock, 24-hour supervision.

In another embodiment, participants can be youth who have already been placed outside the home and the local community into higher levels of care, e.g., residential schools. Participants can also be individuals identified as requiring out-of-home placement due to family crisis and who are at risk of placement into residential schools located outside of their local area or region of residence.

In another embodiment, parent(s) of participants can participate in receiving cross-systems services. Such parent(s) can have identified family preservation goals that relate to their son/daughter achieving stable, safe, and satisfying family relationships.

In another embodiment, to ensure coordination and cross-system access to care for the youth and families served, the cross-systems services provider can participate in a Single Point of Access (SPOA) process. SPOAs are well known in the art. An SPOA process typically includes representatives from all medical and/or social services systems in a community or geographical region, and is designed to improve or maximize cross-systems access for the highest-need populations in the community or region. In one aspect, the SPOA process can enable services offered through the cross-systems service provider to be prioritized to families and youth in the most appropriate circumstances, and to take into consideration all service options that are available within the community.

In one embodiment, the linkage of the plan for services to a SPOA process and to the role played by the youth's Medicaid Service Coordination (MSC) can provide the youth and his/her family with access to services from other systems on a continuing basis. These services can be used, for example, to effect a successful community service plan.

5.2. Services Provided

A method and system is provided for providing cross-systems services to an eligible individual. In one embodiment, the method can comprise the step of delivering a plurality of services to the eligible individual.

The cross-systems services provided can be, in one embodiment, youth- and family-focused. The services can be provided, for example, through ecological approaches in the home, school and community settings well known in the art. This fully integrated service delivery system can promote a continuum of service that prevents gaps in service experienced by youths and families served through more traditional programming.

The method and system can utilize a family systems approach to improve the adaptive behavior functioning of youth and to strengthen the caretaking capacity of the primary family caretakers. The method can use, for example, evidence-based practice and best practices in child welfare.

In one embodiment, cross-systems services can comprise a plurality of services that include, but are not limited to two or more of the following services: intake services, evaluation and assessment services, planning for services (e.g., family-centered planning for services) or services coordination, psycho-educational training and skill development, parent-to-parent support, individual and family therapy, habilitation, family reimbursement, transportation services, crisis stabilization, individualized residential alternative (IRA) residential habilitation or community residential habilitation, respite services, transition services, youth psychiatry services, therapeutic family care or foster care, mental health services, services coordination, succession services, discharge or step-down services, prioritized admission, and wrap-around services (Medicaid Service Coordination (MSC), psychological/psychiatric treatment, case management, Dept. of Social Services casework; mental health clinical modalities, allied health services e.g., physical therapy, occupational therapy, podiatry).

Two or more of these cross-systems services can be components of the method and system for providing cross-systems services, i.e., for a participant youth's and/or family's plan for services. These services are described in more detail hereinbelow. In certain embodiments, two or more services can comprise a service package that is provided to the participant and/or family.

Services can be selected using criteria well known in the art, e.g., evidence-based practice and/or best practices in child welfare. In one embodiment, services can be youth- and/or family-focused and can be provided through an ecological approach in the home, school and community settings. The fully integrated service delivery methods and system provided can provide a continuum of service that prevents the commonly encountered gaps in service that are experienced by families served through more traditional programming. Services can be, for example individualized, responsive, intensive and/or flexible to an individual's needs. Best practices and/or evidence-based interventions well known in the art, derived from the developmental disabilities, child welfare and juvenile justice systems, can be preferably employed.

5.2.1. Eligibility Screening and Intake Services

In one embodiment, the method and system provided can comprise an eligibility screening or an intake services component. According to this embodiment, youth and families who are referred for cross-systems services provision can be screened by a clinical supervisor to determine eligibility criteria. Such criteria include, but are not limited to: a) Does the applicant meet the target population criteria? b) Does the record contain the documentation required to determine eligibility as required or set forth by one or more service providers? c) Will primary caregivers commit to actively participate in the service planning and delivery? d) Have candidates been reviewed through the art-known Single Point of Access process?

5.2.2. Evaluation and Assessment Services

In another embodiment, the method and system provided can comprise providing evaluation services or assessment services.

In a specific embodiment, a psycho-social history can be completed. Other (e.g., medical, psychological, educational) evaluation information can be compiled and utilized to make a final admission decision. In another embodiment, youth and family primary caregivers can then participate in a standardized comprehensive assessment, which is commonly known in the art, to identify strengths, needs, and desired outcomes. Standardized adaptive behavior and family assessment tools known in the art can be administered. In one embodiment, a social worker assigned to the assessment can review a report of the compiled information with the family in order to establish clear and measurable outcomes that form the basis for the development of a plan for services. In one embodiment, the plan for services can be a “Family-Centered Plan for Services” (see below).

5.2.3. Planning for Services

In another embodiment, the method and system provided can comprise a planning for cross-systems services component. In one embodiment, a plan for cross-systems services (“plan for services,” “service plan”) can be prepared or provided. In a specific embodiment, planning for cross-systems services can be family-centered. The primary care giver(s) and youth can join with project team members in the development of a detailed family-centered services plan that specifies the milestones for achieving one or more selected or stated outcomes. Outcomes can reflect the results that are targeted within the family, with the youth, or in circumstances outside the home including school and other social and community situations. Review and reassessment can occur at standard intervals (e.g., every three months) to provide a regular measurement of ongoing progress toward objectives and the efficacy of the interventions that are being applied. This reassessment process can incorporate standardized protocols known in the art and as established within the program evaluation component to measure overall results related to project goals.

5.2.4. Psycho-Educational Training and Skill Development Services

In another embodiment, the method and system can comprise a psycho-educational training and skill development services component. The psycho-educational training and skill development component can apply directly to the primary care givers and is intended to expand their capacity to meet the needs of the youth in a manner which promotes improved adaptive behavior performance and a reduction in targeted challenging behaviors (thereby increasing their ability to remain in the community). In one embodiment, psycho-educational training and skill development can be performed by masters-level social workers who are skilled in art-known family systems approaches and parenting skill training and development.

5.2.5. Parent-to-Parent Support Services

In another embodiment, the method and system can comprise a parent-to-parent support services component. For example, a primary family caregiver can be provided with the opportunity to participate in a parent support group offered through a family resources program, e.g., the Exceptional Family Resources Inc. program (Syracuse, N.Y.). Participation in this support group can provide family members with the opportunity to form relationships with and share effective parenting strategies with other primary care givers who are experiencing similar life circumstances. This component can provide a source of ongoing family empowerment and support.

5.2.6. Individual and Family Therapy

In another embodiment, the method and system can comprise an individual and family therapy component. For example, a social worker (e.g., a masters-level social worker) can provide individual and/or family therapy to enable families to address the multiple and complex issues that arise from caring for a developmentally disabled youth and/or that place the youth at risk of placement outside the home. In a specific embodiment, the goals of family therapy can be based on the assessment of the family's current strengths, needs and desired outcomes. Services can preferably utilize solution-focused and structural family therapy programs in their treatment approach. These art-known programs are based on the principle that home is the best place for change within the entire family system to occur. Such services can assist families in the transition from feelings of doubt and hopelessness, which a potential placement often serves to highlight, to feelings of competence in their ability to care for their youth in their home.

5.2.7. Habilitation Services

In another embodiment, the method and system can comprise a habilitation services component. The plan for each individual participant can identify specific habilitation objectives. These measurable objectives can relate to the specific behaviors and issues that were the basis for referral. Outcomes for an individual can include habilitation objectives that relate to, e.g., the home, community and school settings. A habilitation service can be provided in a manner that recognizes, for example, that each individual's life activities occur within a variety of social and family situations. A habilitation service preferably can transition across the different life circumstances of the youth. Preferably, consistent support and interventions can be provided that are designed to improve the adaptive behavior performance capacity of the youth and to promote more consistent and successful outcomes regardless of the system or circumstances where the individual is functioning.

Habilitation staff and services can be portable, following the youth within their home, community and school environments, and can be available, for example, on a part-time or preferably, on a full-time (24 hours a day/7 days per week) basis. Habilitation services can be similar for served individuals who are living with their families and for those who are living within a community residential option.

A concern of families with cross-systems needs youth is the inconsistency and inadequacy of existing residential habilitation services. Frequently, a family is approved for a sufficient number of residential habilitation hours but provider agencies are not able to provide consistent and reliable staffing due to the part-time nature of the work. In one embodiment, the largest percentage of staff associated with providing services according to the method and system of the invention can be full-time Youth Habilitation Specialists who preferably have both training and experience in working with people with developmental disabilities and in working with youth. In another embodiment, service providers can be trained in family systems approaches, as commonly known in the art, and work within a team framework to ensure that the habilitation services are delivered consistently in the youth's life and in a manner that supports and promotes the growth of the primary care giver (s) and appropriate use of other natural supports. Since youth who will be served by this project may have existing relationships with one or more at-home residential habilitation workers, in one embodiment, the habilitation component can include a transitioning component for transitioning these staff into the cross-systems services to preserve existing relationships.

5.2.8. Family Reimbursement

In another embodiment, the method and system can comprise a family reimbursement component. A family reimbursement fund can be established, for example, that has a certain average or minimum amount per family (e.g., $100-1000, $1000-5000, $5000-10000, etc.). Families that are already experiencing a number of significant challenges can become destabilized by an unanticipated financial need. Access to flexible financial resources can enhance a family's stability and positively impact its ability to successfully achieve its goals and maintain their youth at home.

For example, funds can be available to reimburse expenses not funded through other public resources. In one embodiment, the family reimbursement fund can reimburse expenses that are directly related to the primary caregivers' capacity to support the needs of their disabled youth and will support the family's involvement in community inclusion activities. In one embodiment, the intended use of these funds can be reflected in the cross-systems services plan (e.g., a family-centered plan for services).

5.2.9. Transportation Services

In another embodiment, the method and system comprise a transportation services component. In one embodiment, transportation services can be provided to youth and primary caregiver participants to support family and community travel related to the services identified within the Family Centered Plan for Services. Transportation services provided by service-providing staff can be limited, for example, to those times or circumstances at which no alternative public or private option is available. For example, staff can use a vehicle that is provided by a service-providing component or can use their personal vehicle and receive mileage reimbursement.

This component recognizes that transportation to ancillary services often becomes a stressor and therefore a barrier to families accessing needed community based services (e.g., healthcare, entitlement hearings, court appearances etc.). By providing a secondary transportation back-up, the ability to achieve positive outcomes by using other services can be enhanced. The transportation services component can support greater stability in community settings by assuring continuity of care.

5.2.10. Crisis Stabilization

In another embodiment, the method and system can comprise a crisis stabilization component. For example, one or more family or cross-systems provider team members can be trained in prevention and intervention techniques to avert and stabilize crisis situations within home and community locations where these circumstances occur. In one embodiment, the plan for cross-systems services can specify the precursor behaviors as well as methods for deescalating situations that have the potential for becoming more critical. The crisis stabilization component can focus, for example, on prevention and de-escalation; however, immediate intervention can also be an option to assist the youth through a crisis. A primary care giver and/or a youth habilitation worker can be trained in this aspect of each youth's plan. The youth habilitation worker and the social worker, who are familiar with the youth and his/her plan for services, can be available on call to respond twenty-four hours a day. According to this embodiment, the portability of this crisis stabilization service can provide tangible support to families. For example, if a youth is brought to an emergency facility such as the emergency room of a hospital or psychiatric service, the youth habilitation staff can provide support resources in the emergency setting for those circumstances in which the youth's behavior does not meet emergency psychiatric criteria but requires the security of a psychiatric service setting.

5.2.11. Community Residential (IRA) Habilitation Care

In another embodiment, the method and system can have an individualized residential alternative (IRA) residential habilitation care component. For example, this component can comprise a defined and guaranteed number of beds as a residential option for a participant. A community residential service can provide, for example, supervised residential care in a community while attending a community based educational program.

In one embodiment, the beds in a community residential service component can be designated for youth who have been identified for out-of-home placement. The beds can be, for example, an alternative to out-of-county residential school placements and, when in proximity to the youth's home, can promote and support the ongoing relationship with the primary care giver(s) and the local school district. Services for the youth who reside in this setting can be similar or identical to those who reside at home with primary care givers.

5.2.12. Respite Services

In another embodiment, the method and system can comprise a respite services component. In a specific embodiment, the respite services can be planned (or designated) respite services. For example, a planned (or designated) respite bed can be located in the individualized residential alternative (IRA) for scheduled use by the participants and/or their families. This can include, for example, individuals who live at home with their primary care giver and or those who are in placement in a residential school. For participants in a residential school, regular visits with the individual's family can be supported during scheduled school breaks as part of the longer term effort to transition the individuals back to their home community. A planned respite can be part of the plan for cross-systems services and can afford the family relief in the often tiring role of caring “24/7” (24 hours a day/seven days per week) for a high-need behaviorally involved youth. Respite can also provide an opportunity for the participants to experience pro-social events with familiar support staff and peers outside the family environment.

5.2.13. Transitional Services

In another embodiment, the method and system can comprise a transitional services component, e.g., aging-out transition assistance. For example, all school districts are mandated to begin transition planning with youth at age sixteen. In reality, there are breakdowns in the linkage between this planning and the actual implementation of the plan within the adult service system. In one embodiment, a direct link can be made to the school program of each participant to ensure a direct relationship between the Individual Educational Plan (IEP), the transition plan, and the services (e.g., family-centered services) plan. For example, a special education teacher (e.g., one who has experience working at the secondary level with developmentally disabled students) can provide transitional services. The transitional services provider can work closely with the school and primary care givers to assure that there is a direct relationship and carry-over between the youth's IEP and his/her daily life. The transitional services provider can participate, for example, in meetings such as parent/teacher conferences and act as a resource to school personnel and families. In addition, the transitional services provider can act as a link and resource between the cross-systems service provider and the school to assist school personnel to address the youth's adaptive behavior needs. The transitional services provider can work, for example, with the MSC to coordinate educational and vocational planning. In another embodiment, when each youth turns a specific age, e.g., eighteen years of age, the transitional services provider can work closely with the primary care giver, the MSC and the youth on the steps to implement the plan to transition from the educational to adult service system.

In one embodiment, youth who are placed in residential schools out of their regional area of residence can work with the transitional services provider to return to their residence by a specified age or date, e.g., by their twenty-second birthday.

5.2.14. Youth Psychiatry Services

In another embodiment, the method and system can comprise a youth psychiatry services component. In one embodiment, the youth psychiatry component can comprise direct clinical services, including but not limited to psychotropic medication management and/or consultation services. The direct clinical service component can be accessed, for example through an outpatient psychiatric service, e.g., a single-source outpatient psychiatric service that is funded via the youth's third party payer (e.g. Medicaid). In another embodiment, the youth psychiatry services component can comprise consultation services, e.g., staff training. In one embodiment, these services can be paid for with funds provided by the cross-systems service provider, since third-party coverage does not allow indirect services. Consultation and training can promote the development of the habilitation staff and the capacity of the primary care giver to meet the ongoing needs of the participants through an increased understanding of the use of medications in the care of each youth.

5.2.15. Therapeutic Family Care Services

In another embodiment, the method and system can comprise a family care or foster care component, and preferably, a therapeutic-level family care or foster care component. In one embodiment, therapeutic-level family care (or foster care) homes can be used to provide short-term intensive clinical and behavior management supports in a family setting other than the home of the primary caregiver. Such higher levels of care can be indicated when the youth is at risk of out-of-home placement and short-term stabilization is required.

In one embodiment, a cross-systems services provider can enter into an agreement with an organization that oversees or supervises licensed therapeutic family care or foster care homes. Such an organization can, for example, conduct recruitment and training requirements for the homes they oversee or supervise. Therapeutic family care providers can, for example, undergo program certification, meet operational requirements, receive payments in accordance with current rate schedules, etc. In one embodiment, a monthly stipend can be paid to a therapeutic family care provider to maintain system capacity and therefore bed availability. This stipend can be paid, for example, regardless of occupancy. Such therapeutic family care components are well known in the art (see, e.g., Liberty Resource's Therapeutic Foster Care program, Syracuse N.Y., operated since 1997).

In one aspect, a therapeutic family care services component can create system capacity that prevents out-of-home placement. It can also establish a program capacity for continuing the youth in school, other support services and most importantly involvement with the family/primary caregiver so that the choice is not only between permanent placement and discharge.

5.2.16. Cross-Systems Services Coordination

In another embodiment, the method and system can comprise a cross-systems services coordination component. In one embodiment, cross-systems services coordination can be performed by one or more individuals. In another embodiment, cross-systems services coordination can be performed by a team of individuals. In a specific embodiment, a youth participant who lives at home with a primary caregiver can receive services coordination from a services coordinator associated with a provider that is independent of the cross-systems services provider. The services coordinator can work closely with the MSC to ensure integration and coordination of services.

In a specific embodiment, the cross-systems services coordinator (or coordination team) can prepare, or assist in the preparation of, the plan for providing cross-systems services.

In another embodiment, the cross-systems services coordinator (or coordination team) can coordinate or effect the carrying out of the plan for providing cross-systems services.

5.2.17. Succession Services

In another embodiment, the method and system can comprise a succession services component. For example, a youth participant can leave the system providing cross-systems services based on one of the following criteria:

a) The youth reaches a specific age, e.g., the age of twenty-two (22), and a transition plan has been implemented that insures age appropriate community based services and support for a young adult;

b) Project staff and the primary caregiver determine that the youth has achieved all target outcomes, no longer requires the intensity of the program project services, and a transition plan has been implemented which provides a reasonable expectation for continued success through the continued provision of community based services and supports; or

c) A formal risk assessment of the youth determines that there is a significant safety risk for the youth or others which requires a more secure level of care.

In another aspect of this embodiment, habilitation, vocational, and residential resources can be available and accessible to support the young adult population that is aging out of the project's community-based component or that is aging out of residential school placements.

5.2.18. Prioritized Admission

In one embodiment, the method and system can comprise a prioritized admission services component. A waiting list of eligible youth and families can be established once the service opportunities are filled. As youth and families transition out from the project, admission selections can be made from this waiting list.

5.2.19. Wrap-Around Services

In certain embodiments, the method and system can comprise a wrap-around services component. In one embodiment, a service package can comprise provision of wrap-around services that are identified from a pool of services available and known in the art to support the child, family and/or primary caregiver. For example, wrap-around services can be social services that are either formal services or informal resources. Wrap-around services can be community-based; individualized, strength-based and designed to meet the needs of children and families to promote success, safety and permanency in home, school and community; culturally competent; team-driven, involving the child, family, natural supports, agencies, schools and the community services working together to develop, implement and evaluate the individualized plan; interagency, community-based and collaborative. Wrap-around services can also take into consideration outcomes that can be determined and measured for the child and/or family, the program and the system, and can include flexible approaches and flexible funding to meet each of the child and/or family's needs.

Wrap-around services can include, but are not limited to Medicaid Service Coordination (MSC), psychological/psychiatric treatment, case management, Dept. of Social Services casework, mental health clinical modalities, and allied health services, e.g., physical therapy, occupational therapy, podiatry, etc.

5.3. Service Locations

In another embodiment, services and supports can be located in the home or school, or are community-based. Service locations can be preferably within the “natural ecology” in which the youth and the family are functioning. The level of service intensity can be a function of the needs of each youth and family. Youth and their families can receive, for example, services primarily oriented to supporting family involvement during school breaks. Services in preparation for transition back to the youth's home (or community) can also be provided in the home setting and, on a limited basis, at the youth's residential setting when return home is imminent. The target for returning these youth can be prior to a specific age or date, e.g., prior to their twenty-second birthday.

In one embodiment, individuals can live at home, where they can be maintained within their home environment and not require the higher and more expensive level of individualized residential alternative (IRA) residential habilitation care.

5.4. Cross-Systems Service Provider Staff

According to the provided method and system, the staff providing cross-systems services can include, but is not limited to: a clinical supervisor, a residential supervisor, an intensive family therapist, a psychologist, a resource teacher or special education teacher, a consulting psychiatrist, an evaluator, a senior youth habilitation specialist, and a youth habilitation specialist.

In one embodiment, the clinical supervisor can oversee the system for providing cross-systems services. In another embodiment, the residential supervisor can oversee the IRA.

In another embodiment, to ensure a desired level of service intensity, responsiveness and flexibility, masters-level social workers experienced in family systems can serve a group of youth (e.g., 7-8 youth) and their families at a given time.

In another embodiment, staff who provide direct habilitation service can be portable, allowing for deployment based on youth-specific needs as opposed to program location. For example, as needed, habilitation staff can follow the youth whether s/he is in school, at home or in an IRA. Senior youth habilitation specialists can provide support and direction to habilitation staff for their work in the IRA and in the family settings.

In one embodiment, the professional services available within the team coordinating cross-systems services can also include a clinical psychologist experienced in assessment and behavior management planning for developmentally disabled adolescents with significant behavior needs. In another embodiment, in addition to the assessment and planning, the psychologist can work directly with habilitation and social work staff and family members on the methods for implementing behavior plans.

In another embodiment, a part-time consulting youth psychiatrist can provide regular clinical consultation and training to the team and family members around the specific needs of the youth who have a mental health diagnosis and/or who are being treated with psychotropic medications. Typically such training and consultation is not supported by third-party payers but greatly assists in understanding and integration by the primary caregivers.

In another embodiment, a full-time education specialist with secondary education experience specifically involving developmentally disabled adolescents can provide transitional services that promote increased continuity of service between school and home, and can provide a direct linkage to assist families and youth move through the transition from school based services to adult community based services.

5.4.1. Qualifications of the Staff

In another embodiment, the staff providing cross-systems services coordination can have selected or desired qualifications. The following are non-limiting examples of the types of qualifications that can be selected or desired for staff. Complete job descriptions can be written for each position with more detailed description of duties and qualifications. Final qualifications can include experience and education substitutions known in the art, as may be appropriate to the respective title. Substitutions can be preferably comparable to the qualifications set forth below:

Clinical Supervisor: Masters in Social Work or related field with five years of experience in direct services to youth and families involved with the juvenile justice, child welfare, mental health, and or developmental disabilities field. Must have at least one year of supervisory experience. Demonstrated competence in meeting the developmental, emotional, and psychological needs of youth and families, and must operate from a family systems, strength based approach to services. Preference will be given to candidates who have prior experience with evidence based family systems modalities.

Residential Supervisor: The qualifications are the same as for the Clinical Supervisor except that only three (3) years of experience will be required. Residential experience will be preferred.

Intensive Family Therapist: Masters in Social Work or related field and two years of experience working with youth and families. Must operate from a family systems and strength based approach to services.

Psychologist: Ph.D. in Psychology and two years of direct experience or Masters Degree in Psychology with four years direct experience in adaptive behavior assessment and individualized behavior management planning with the developmentally disabled. Preference will be given to candidates who have worked directly with primary care givers on plan implementation within family and community settings.

Special Education Teacher: Masters Degree in Special Education with a minimum of two years of experience working with developmentally disabled adolescents within a secondary school setting.

Consulting Youth Psychiatrist: Must be a Board Certified Youth Psychiatrist with experience in the diagnosis and treatment of developmentally disabled adolescents.

Evaluator: Masters Degree in related field with three years of research design and program evaluation experience.

Senior Youth Habilitation Specialist: Bachelor or Associates degree in a related field and three years of experience working with youth or developmentally disabled individuals or related combination of education and experience.

Youth Habilitation Specialist: Bachelor or Associates Degree and two years of related experience or high school diploma and four years of related experience.

5.5. Duration of Providing Cross-Systems Services

In one embodiment, cross-systems service provision can be ongoing and serves each youth until s/he reaches a certain specified age, e.g., 18, 21, 22, etc. Transition of a participant from receiving cross-systems services preferably occurs under the circumstances described in Section 5.2.17 (Succession services) above. As individual participants are successfully transitioned to the adult system or to independence, youth from the wait list can be admitted such that services are perpetual.

In another embodiment, cross-systems service provision can be for a defined period of time, e.g., 6 months to one year, 1-2 years, 2-5 years, etc.

In another embodiment, cross-systems service provision can be reauthorized for a defined additional period of time or until the youth reaches a certain specified age.

5.6. Outcomes of Providing Cross-Systems Services

In one embodiment, provision of cross-systems services can have a desirable or preferred outcome. For example, one preferred outcome can be the creation of continuum of community care that successfully provides services to cross-system youth and their families. These hard-to-serve youth are engaged in a level of care that effectively treats their multiplicity of presenting and/or co-occurring disorders. As a result, youth avoid restrictive residential placements and achieve permanency.

In another embodiment, the method and system can comprise a component for measuring outcomes at the program level and at the consumer level. On the consumer level, specific outcome goals can be developed with each family.

In another embodiment, the following five quantifiable aggregate outcome goals can be used:

Outcome Target # 1: There will be a statistically significant improvement in eighty percent (80%) of the targeted adaptive behaviors as specified in each youth participant's plan for services. This can be an increase in desired behavior or decrease in negative behavior.

Outcome Target # 2: Ninety percent (90%) of the primary caregiver participants will self report and evidence, after each six month interval, increased confidence, capability, and commitment to care for the youth participant, and will be able to specify the changes which have occurred in their lives and the lives of the youth which have contributed to these improvements.

Outcome Target #3: One hundred percent (100%) of the youth participants will demonstrate a seventy five percent (75%) reduction in their use of higher levels of public service interventions (e.g., Family Court and probation involvement, police involvement etc.).

Outcome Target #4: Seventy-five percent (75%) of the twenty (20) community-based youth participants who have not been involved in age appropriate pro-social activities (such as school, clubs, social organizations, and religious participation) will become involved.

Outcome Target #5: Seventy five percent (75%) of the families served will improve their network of informal social supports in the community and demonstrate skill at successfully accessing a range of supports (informal to formal) as needed.

In certain embodiments, continued responsiveness and participation can be provided through: a) the relationships that develop between the staff and the families (who are an integral part of the service team); b) gathering and assessing consumer feedback; c) a formal reassessment process and; d) incorporation of ongoing feedback from the other systems and/or systems providers that are serving the participants.

Oversight systems well known in the art can promote the health, safety and protection of individuals and ensure the continuing high quality of services. Quality assurance programs and/or continuous quality improvement programs known in the art can be used to monitor adherence to regulatory requirements and the achievement of identified indicators of quality.

In one embodiment, the staff coordinating the cross-systems service provision can also include an evaluation committee, which is separate from the operational chain of command, and which oversees a comprehensive evaluation process.

The method and system provided herein can preferably conform to all general and program-specific government regulations, policies and/or guidelines, although a waiver can optionally be obtained when strict adherence would compromise the desired outcome. If a regulatory waiver is granted, the cross-systems service provider can preferably establish with the agency granting the waiver a satisfactory alternative to the waived standard. For example, as an alternative to having a written “Residential Habilitation Plan” and to ensure portability of services, each participant could have a “Family Centered Plan for Services” which could include the specific habilitation services to be provided to each developmentally disabled youth. Regulatory reviews can be conducted, for example, by a government regulatory agency.

For example, cross-systems services or activities that may be at variance with government regulation and/or policy could include, for example: a) the portability of habilitation services vs. services being program-specific; b) the ability to utilize habilitation resources as a support across other public systems; c) the blending of habilitation and clinical services vs. separating those services; d) the establishment of a permanent planned respite bed within the residential services option; e) a more intensive staff to participant ratio of both clinical and habilitation staff; f) a cash stipend for two family care providers.

5.7. Budget

In another embodiment, the method and system can comprise an established or proposed budget component. Budgetary calculations for providing cross-systems services to a particular community or region can be made, for example, according to methods well known in the art.

5.8. Evaluation of Efficacy of Providing Cross-Systems Services

In another embodiment, the method and system can comprise an evaluation component that measures the efficacy of the project based on specific, objective outcome measures.

For example, the efficacy and success of providing cross-systems services can be determined on a periodic (e.g., annual, semi-annual basis). In one embodiment, objective, measurable and quantifiable outcome goals that clearly demonstrate that the consumer's quality of life has improved as a result of receiving services can be assessed using methods well known in the art. Assessment criteria are well known in the art and can include, but are not limited to: progress toward program and client outcome goals, and analysis and/or justification for any variance in the achievement of projected outcomes. Reports can be reviewed by agency management and plans can be implemented according to art-known principles to either adjust the goals themselves or to adjust the intervention to maximize opportunity for success.

In another embodiment, program outcomes can be measured. For example, the benefits of providing cross-systems services can be assessed through a number of art-known quantitative and qualitative methods. For example, an evaluator, optionally in conjunction with an evaluation committee, can be responsible for ensuring the integrity of the evaluation process. Section 6.1 (Example 1: Evaluation of a cross-systems services program) describes the measurement methodology in detail.

The following examples are offered by way of illustration and not by way of limitation.

### 6. EXAMPLES

### 6.1. Example 1

### Evaluation of a Cross-Systems Services Program

This example describes methods for evaluating a cross-systems services program.

6.1.1. Project Evaluation Committee

The project evaluation was conducted by an independent evaluation committee comprised of two parents, one New York State Developmental Services Office staff person who was trained and experienced in evaluation design and implementation, two representatives from partner agencies of which at least one was from an Onondaga County (New York) Government Human Services Department, a Coordinator of Quality Improvement and a Project Evaluator. The Committee was chaired by the Coordinator of Quality Improvement who reported progress and findings to a Deputy Executive Director and to an Executive Director. This organizational approach assured broad-based participation by stakeholders and provided independence from the operational component of the project. The Committee was responsible for adopting the final design of the project evaluation and for assuring that the conduct of the evaluation had integrity and was rigorous. The Committee considered a variety of evaluation methods that potentially included a comparative group in another region and a longitudinal study. The Committee also sought outside technical assistance as required to complete this evaluation.

The Committee met regularly to oversee implementation of the evaluation methods, to review data collection and to ensure the ongoing commitment to the evaluation process and established timelines. Analysis of information, findings and conclusions were considered by the Committee before interim and final written reports were issued.

6.1.2. Methods Used for Evaluation

The cross-systems services coordination team measured the benefits of this project through a number of quantitative and qualitative methods. The Evaluator, in conjunction with the Program Evaluation Committee, was responsible for ensuring the integrity of the evaluation process. A six-month evaluation summary report was developed in the first year, with annual evaluation reports thereafter. Evaluation components included, but were not limited to, measurement of the following:

Achievement of Individualized Outcome Goals: Each youth and family's outcome goals was determined during the assessment process and incorporated into a Family-Centered Plan for Services. Formal Plan review meetings, held every 90 days, were the forums for evaluating progress and reassessing service needs. The outcome goals and the subsequent review of these outcomes were expressed in an empirical fashion, which were quantified and measured. Every member of the team had a clear, concrete picture of the behaviors that the youth, family and service providers needed to demonstrate. These behavioral objectives were compared with the actual performance of the youth and family and gaps between performance and objectives were reviewed and addressed. All of this information became part of the case record and substantiated that services were, in fact, having the intended impact. Quantifiable data sets related to specific adaptive behavior objectives were developed and collected. These were analyzed utilizing standardized assessment instruments according to methods well known in the art.

Attainment of Program Outcome Goals: The project determined a number of aggregate goals which reflected the project's intended impact. On a semi-annual basis, data was collected from individual files and analyzed on an aggregate level in order to evaluate program effectiveness. Information was compared on a comparative pre- and post-admission basis. Examples of program goals that were measured on an aggregate basis included, but were not limited to: reduction in inappropriate use of the juvenile justice, probation and child welfare systems; reduction in number of visits to the emergency psychiatric service; increase in number of completed days of school attendance; and decrease in incidences of behaviors which result in juvenile justice involvement.

Consistent with current government agency practice known in die art, statistics were gathered and analyzed on a monthly basis using routine methods to measure utilization.

Consumer Satisfaction Surveys: The cross-systems services coordination team administered a program-specific consumer satisfaction survey when a participant was discharged from the cross-systems service program, or annually, whichever occurred more frequently. A family/consumer satisfaction survey designed according to art-known methods was used to assess consumer/family satisfaction, to track primary caregivers' assessment as to whether their youth was making progress toward goal attainment and to gather input regarding program improvement. T his instrument was administered at the time of admission to establish baseline information, and re-administered every six months thereafter to assess progress from the perspective of the primary care giver. Surveys were completed independent of project staff to assure objectivity and candor.

External Stakeholder Surveys: Surveys were also administered to external stakeholders. A survey designed specifically for this program served as an important source of information to the agency and project staff on the actual experience stakeholders had with the cross-systems services program. Concerns of stakeholder participants were addressed, for example, through a continuous feedback process. Stakeholder satisfaction surveys were randomly administered to representative segments of stakeholders, e.g., at six month intervals. Examples of stakeholders included, but were not limited to: school districts, county or regional Departments of Social Services, Mental Health and Probation departments, and community or regional psychiatric emergency programs.

The cross-systems services program was held accountable to established standards of excellence. These standards were articulated in writing and maintained at each program site. Adherence to standards was reviewed on a regular (e.g., monthly) basis informally and on an annual basis formally.

6.1.3. Conducting Evaluations

Responsibility for the evaluation component of the cross-systems services program was place within a Quality Assurance/Improvement department associated with the program. The Coordinator of this department supervised the Program Evaluation Specialist, who selected and designed the evaluation protocols, data collection and tracking systems and compiled all information for analysis. The Program Evaluation Specialist worked closely with the Program Evaluation Committee, provided regular reports for the Committee's review and feedback to project staff to support progress toward achieving project outcome goals.

Consumer Satisfaction Surveys were administered independently of staff. This was to protect the identity of consumers (participants) and families so that they felt safe in communicating thorough and honest feedback.

Consumers (participants) had a number of options available for giving input so as to ensure that their preferred method of communication was available to them. How each participant or family gave input was as individualized as the service plan itself. Some individuals were comfortable in responding to a written survey; some preferred a face-to-face interview and others were more comfortable in a group. All options were available. If a consumer was not able to communicate verbally, his/her input was gathered through the family, his/her advocate and/or the cross-systems services coordinator.

6.1.4. Incorporation of Feedback

A Continuous Quality Improvement (CQI) program reviewed all outcome data (including results of the consumer opinion surveys). The feedback process was immediate. Suggestions for program improvement were made immediately back to the program supervisor with a copy going to the Division Director and Deputy Executive Director. In addition to providing written recommendations, the CQI Coordinator worked with each team to ensure implementation of recommendations for improved practice. The CQI process ensured that outcome information and participant feedback was utilized to make improvements to service delivery.

Individual survey information was also reviewed in the aggregate and summarized for submission to the Deputy Executive Director, Executive Director and Board of Directors. Evaluation information provided a continuous source of information that was used, for example, for ongoing improvements in providing cross-systems services. Trend information was used to strengthen and/or modify the program with specific follow-up plans developed by the Division Director. Aggregate consumer feedback was also presented to the Program Evaluation

Committee for review, analysis and recommendations within the context of the program evaluation activity and outcome measurement.

In addition, periodic and annual reports, which presented collected data, analysis, findings and conclusions, were presented to the family participants and all stakeholders.

6.2.1. Admission Criteria

For a child to be deemed eligible for the cross-systems program, the child must meet all five criteria:

1. Must be a child or adolescent under 18 years of age that requires services from two or more of the following systems:
a. New York State Office of Mental Retardation and Developmental Disabilities (OMRDD)
b. New York State of Mental Health (OMH)
c. Child Welfare/New York State Office of Children and Family Services (OCFS)

### 2. Is at a high risk of out-of-home placement and requires a different set of services that he/she is already receiving or is disrupting from his/her current placement.

3. Exhibits one or more of the following behaviors:
a. Away without leave (AWOL)
b. Aggressive/assaultive
c. Sexually reactive
d. Sexual offender
e. Fire Setter
f. Drug/substance abuse
g. Self mutilating
h. Suicidal
i. Other difficult behaviors

### 4. The child cannot be safely managed in the current setting and is putting staff and other residents at risk of harm or the child may not be responding to treatment and may require a different level of care.

5. Current systems have been unable to find an appropriate placement. A diligent search must have been done to secure a placement for the child by the referring agency prior to this referral, however; the needs of the child can not be met in the current programs.

Once a child was deemed eligible, a family advocate was assigned to work with the child and family through the duration of the child's placement in this program.

Concurrently, a comprehensive evaluation was completed on the child and family by the multi-disciplinary team. This team comprised psychiatrist, a psychologist, an educational specialist, a nurse practitioner and/or a registered nurse, a family advocate, a family specialist (CSW) and other specialists as needed, such as substance abuse specialist, sex offender specialist, etc. who were trained in cross-systems work. This process included reviewing previous evaluations and determining what additional assessments were needed. Based on the information gathered, the team made a determination as to eligibility of the case to the cross-systems program. If the team determined that there were existing services that could meet the child's needs, the services coordinator provided consultation and referred the case back to the existing systems. This could be followed up in writing. If the team determined that there were no existing services, a cross-systems services coordinator was assigned to the case and moved into services coordination.

The services coordinator assumed the lead role in the case and acted as the case manager overseeing the case from the day the referral was received to the discharge from the cross-systems services program. There were others who may have participated in the planning of the case, however, everyone reported to the services coordinator for approval and direction.

6.2.2. Services Coordination and Wrap-Around Services

The cross-systems services coordinator, the family advocate, other supports identified by the family and the evaluation team determined the service package that was needed, worked with the family and child to identify the expected outcomes, and developed a discharge plan. The child was evaluated for one of four service packages, utilizing the least restrictive placement that would meet the child's needs.

In certain cases, a service package provided wrap-around services that were identified from a pool of services available and known in the art to support the child, family and/or primary caregiver. For example, wrap-around services could be social services that were either formal services or informal resources. Wrap-around services could also be: community-based; individualized, strength-based and designed to meet the needs of children and families to promote success, safety and permanency in home, school and community; culturally competent; team-driven, involving the child, family, natural supports, agencies, schools and the community services working together to develop, implement and evaluate the individualized plan; interagency, community-based and collaborative. Wrap-around services could also take into consideration outcomes that could be determined and measured for the child/family, the program and the system, and could include flexible approaches and flexible funding to meet each of the child and family's needs,

Wrap-around services included, but were not limited to Multisystemic Therapy (MST), Medicaid Service Coordination (MSC), psychological/psychiatric treatment, case management, Dept. of Social Services casework; mental health clinical modalities, and allied health services, e.g., physical therapy, occupational therapy, podiatry.

In some cases, a reauthorization process was put in place by a reauthorization team to ensure that the services provided to the child and to the family were adequate and appropriate. If it was determined that the child was in the appropriate placement, the case could be reauthorized with a new date set to have the case reviewed by the reauthorization team.

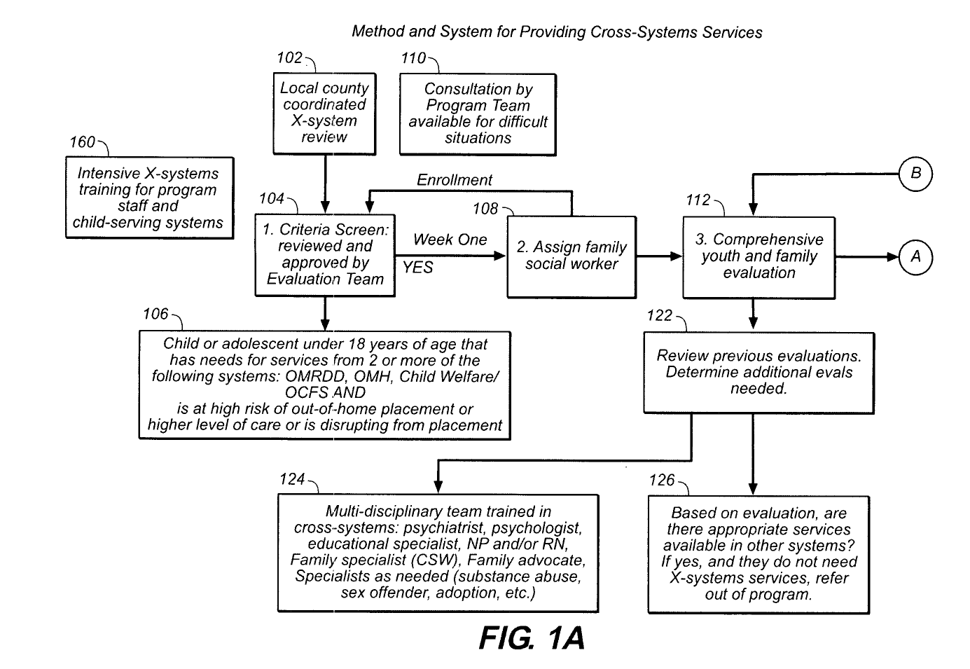

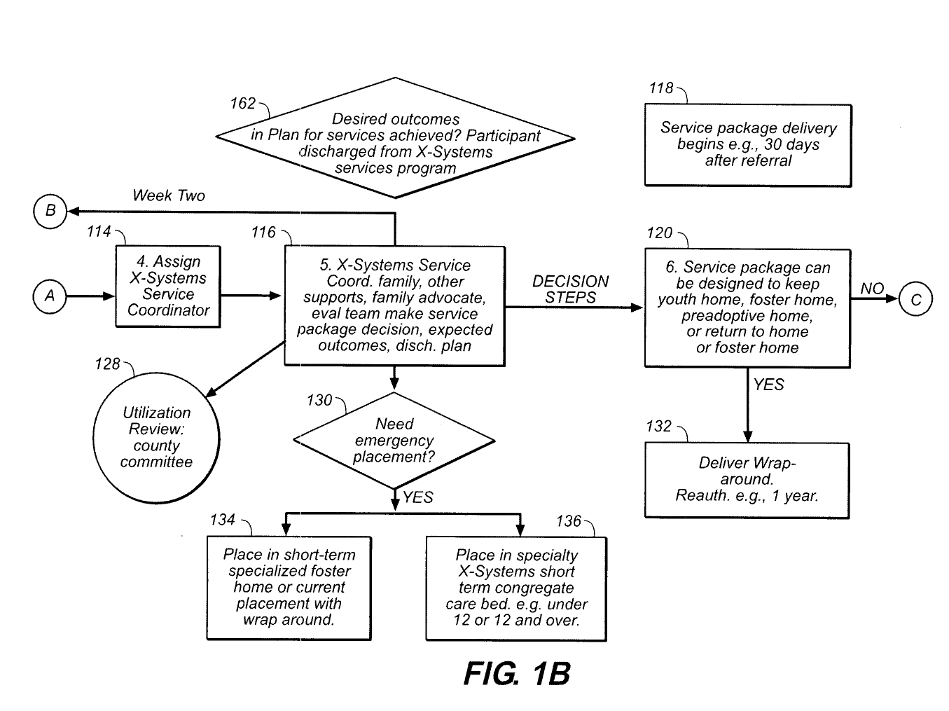

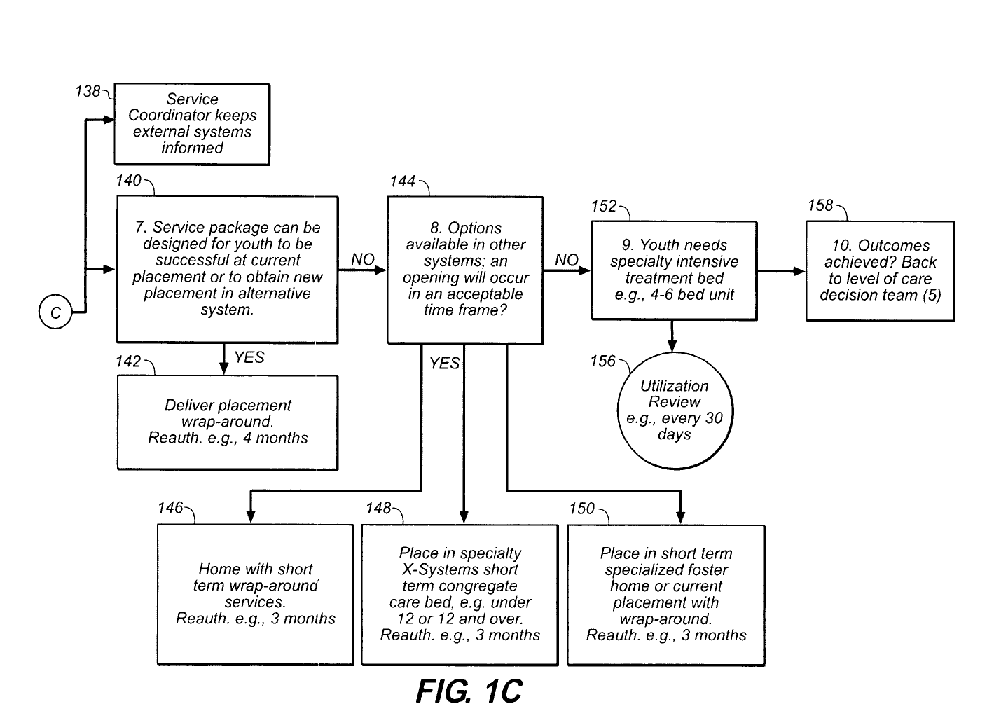

FIG. 1 is a flow diagram showing an example of an embodiment of the method and system for providing cross-systems (“X-systems”) services in accordance with the principles of the present invention.

During week 1, a potential participant is screened 104 using admission criteria, and the screen is reviewed and approved by an evaluation team. Admission criteria 106 used in the screen can be, for example:

1. Child or adolescent under 18 years of age that has needs for services from 2 or more of the following systems: OMRDD, OMH, Child Welfare/OCFS, and

2. Is at a high risk of out-of-home placement or higher level of care or is disrupting from placement, and

3. Exhibits one or more of the following behaviors: away without leave (AWOL), Aggressive/Assaultive, Sexually Reactive/Offender, Fire Setter, Drug Substance Abuse, Self-Mutilating/Suicidal, or other difficult behaviors, and

4. Cannot be safely managed in their current setting, and

5. Current systems have been unable to find an appropriate placement.

A local county or regional cross-system (“X-system”) review 102 can also be performed.

If admission is approved, the participant is assigned a family advocate 108. Consultation by the program team is also available for difficult situations 110.

During week 2, a cross-systems services coordinator, family, other supports, family advocate and the evaluation team make service package decisions, determine an expected outcome(s) and discharge plan 116. An admitted participant can undergo a comprehensive youth and family evaluation 112. Previous evaluations can be reviewed by the evaluation team and they can determine whether additional evaluations are needed 122. The participant can also be assigned a cross-systems services coordinator 114 during week 2.

Service package delivery can begin, for example, 30 days after referral 118.

A service package can be designed to keep youth at home, in a foster home, in a preadoptive home, or return to home or to a foster home 120. If such a service package can be designed, then wrap-around services can be delivered with, e.g., a one-year reauthorization option 132. If such a service package cannot be designed, then the services coordinator keeps external systems informed 138.

A multi-disciplinary team trained in cross-systems can be used for further evaluation: e.g., a psychiatrist, a psychologist, an educational specialist, and NP and/or an RN, a family specialist (CSW), a family advocate, and/or a specialist as needed (specialist for substance abuse, sex offender, adoption, etc.) 124. Based on the evaluation, it can be determine whether there are appropriate services available in other service (e.g., social service) systems. If there are other systems available and the participant does not need cross-systems services, then the participant can be referred out of the cross-systems services program 126.

A utilization review can be performed, e.g., by a county or regional committee 128.

If emergency placement is needed 130, in one embodiment, the participant is placed in short term in, e.g., a specialized foster home, or kept in their current placement with wrap-around services for their family or caregiver 134. In another embodiment, the participant is placed in a specialty cross-systems congregate care bed designated for a child in a specific age group, for example, under 12 years of age or 12 years of age and over 136. In one embodiment, the placement can have a reauthorization option, e.g., a 14-day reauthorization option.

A service package can be designed for the participant to be successful at their current placement or to obtain a new placement in an alternative system 140. Under these circumstances, placement wrap-around services can be delivered. In one embodiment, the placement wrap-around services can be delivered with a reauthorization option, e.g., a 4-month reauthorization option 142.

If such a service package cannot be designed for the participant, then it can be determined whether good options are available in other systems, and/or whether an opening will occur in an acceptable time frame 144. If this is the case, then in one embodiment, the participant can be placed at home with short term wrap-around services and, e.g., a 3-months reauthorization option 146. In another embodiment, the participant can be placed in a specialty cross-systems short term congregate care bed designated for a child in a specific age group, e.g., less than 12 years of age or 12 years and over 148. In one embodiment, the placement can have a reauthorization option, e.g., a 3-months reauthorization option. In another embodiment, the participant can be placed in a specialized foster home or remain in his/her current placement with wrap-around services and a reauthorization option, e.g., a 3-months reauthorization option 150.

In one embodiment, it is determined that the participant needs a specialty intensive treatment bed in, for example, a small unit (e.g., a 4-6 bed unit) 152. For example, depending on need, the participant can be placed in a behavioral intensive unit for children in a specific age group, e.g., under 12 years old or 12 years old and older, a behavioral intensive unit for children with developmental disabilities (DD) in a specific age group, e.g., under 12 years old or 12 years old and over, an intensive sex offender unit, an intensive sex offender unit for offenders with developmental disabilities (DD). In one embodiment, the unit includes a special education designation (SED)-approved specialized school. The reauthorization time frame in this embodiment can be, for example, 6 months, and a utilization review can be performed periodically (e.g., every 30 days) 156.

If the specified or desired outcomes are achieved as specified in the plan for services, then the participant's case can be re-reviewed 158 by the cross-systems coordinator and other members of the care decision team 116.

In another embodiment, program staff and child-serving systems receive intensive cross-systems training 160.

When outcomes that are desired or specified in the plan for cross-systems services are achieved, then the participant is discharged from the cross-systems services program 162.

6.2.3. Emergency Service Package (See FIG. 1, Box 5, 116)

This package is used if a placement is needed on an emergency basis. There are two options for a child under these circumstances. The first option is to place the child is a specialized foster home or current placement with wrap-around services until the child can be placed in the appropriate placement. The second option is for the child to be placed in a cross-systems short-term bed with wrap-around services until the child can be placed in the appropriate placement. Reauthorization timeframe is approximately 14 days.

6.2.4. Service Package 1 (See FIG. 1, Box 6, 120)

This is the least restrictive placement. The child may be kept in his/her own home, a foster home, the pre-adoptive home or may be returned home or to a foster home with wrap-around services identified and put in place. The cross-systems services coordinator works with the family to begin building community connections. Reauthorization timeframe: 1 year.

6.2.5. Service Package 2 (See FIG. 1, Box 7, 140)

This package is designed to keep the child at his/her current placement or to obtain a new placement in an already existing agency with wrap-around services identified and put in place. Reauthorization timeframe: 4 months.

6.2.6. Service Package 3 (See FIG. 1, Box 8, 144)

This package is designed for children who have had a placement identified for them. There are three options for this child. The first option is to use service package 1 until the child can be placed in the appropriate placement. The second option is for the child to be placed in a short-term bed (therapeutic foster care, group home, institution, etc.) with wrap-around services until the child can be placed in the appropriate placement. The third option is for the child to be placed in a specialized short-term foster home with wrap-around service until the child can be placed in the appropriate placement. Reauthorization timeframe: 3 months.

6.2.7. Service Package 4 (See FIG. 1, Box 9, 152)

This type of placement is used as the last alternative. This is a specialty placement that is, for example, a 4-6 bed program with high staff ratios. Staff in these units can be trained in cross-systems services and are flexible in working with children who have multiple service needs. All units can include a State Education-approved specialized school and can have access to the same pool of service professions that the wrap-around services access. Length of stay in any of these units will depend on how the child is responding to treatment For the OMRDD population, children generally require one year to stabilize. The goal is to transition children out of this level of care as quickly as possible. Six units can be developed for the following populations:

Behavioral intensive unit for children under 12 years old.

Behavioral intensive unit for children over 12 years old.

Intensive sex offender unit.

OMRDD behavioral intensive unit for children under 12 years old.

OMRDD behavioral intensive unit for children over 12 years old.

OMRDD intensive sex offender unit.

Reauthorization timeframe: 6 months.

Each case in this program is evaluated periodically, e.g., every 30 days, by the multi-disciplinary team to determine the status of the case. This team makes a recommendation that the current services be continued, that a movement occurs within one of the other service packages, or that the child be discharged from the program. The discharge may be into a voluntary agency setting or may be a return home.

6.2.8. Discharge/Step-Down

Discharge planning begins at the beginning of the case in the services coordination stage. The multi-disciplinary team is involved with the case throughout the child's placement and is involved in determining the level of care once the child is ready to be moved. The child can be moved out of the program into an existing program or be stepped down into one of the less restrictive service packages. The cross-systems services coordinator, the family advocate, and the evaluation team will meet on a monthly basis to review the case and determine this with input from the family and child.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

What is claimed is:

1. A system for providing cross-systems services to an individual in need of cross-systems services comprising:
a. a list of eligibility criteria to be evaluated, wherein the eligibility criteria are criteria concerning a need for cross-systems services;
b. a list of attributes by which an eligible individual in need of cross-systems services is evaluated;
c. an evaluation;
d. a cross-systems services coordinator or coordination team; and
e. a plan for services.

2. The system of claim 1 wherein the plan for services is coordinated by the cross-systems services coordinator or coordination team.

3. The system of claim 1 wherein the plan for services is based on the evaluation.

4. The system of claim 1 wherein the individual is a developmentally disabled adolescent.

5. The system of claim 1 wherein the list of attributes comprises attributes established by a standardized comprehensive assessment.

6. The system of claim 1 wherein the plan for services comprises a service package.

7. The system of claim 6 wherein the service package comprises a plurality of services selected from the group consisting of: intake services, evaluation and assessment services, family-centered planning for services, psycho-educational training and skill development, parent-to-parent support, individual and family therapy, habilitation, family reimbursement, transportation services, crisis stabilization, individualized residential alternative (IRA) residential habilitation or community residential habilitation, respite services, transition services, youth psychiatry services, therapeutic family care or foster care, mental health services, services coordination, succession services, discharge or step-down services, prioritized admission, and wrap-around services.

8. A method for providing cross-systems services to an individual in need of cross-systems services comprising the steps of:
a. Screening a potential candidate for admission criteria to determine eligibility for cross-systems services;
b. Identifying an eligible individual in need of cross-systems services for admission to cross-systems services by the screening;
c. Admitting the eligible individual;
d. Evaluating the eligible individual; and
e. Providing cross-systems services to the eligible individual.

9. The method of claim 8 wherein the eligible individual is a developmentally disabled adolescent.

10. The method of claim 8 wherein the eligible individual is a family member or primary caregiver of a developmentally disabled adolescent.

11. The method of claim 8 wherein the step of providing cross-systems services to the eligible individual comprises preparing a plan for services.

12. The method of claim 8 wherein the step of providing cross-systems services to the eligible individual comprises providing a cross-systems services coordinator or coordination team.

13. The method of claim 11 wherein preparing the plan for services is coordinated by the cross-systems services coordinator or coordination team.

14. The method of claim 11 wherein the plan for services comprises a service package.

15. The method of claim 14 wherein the service package comprises a plurality of services selected from the group consisting of: intake services, evaluation and assessment services, family-centered planning for services, psycho-educational training and skill development, parent-to-parent support, individual and family therapy, habilitation, family reimbursement, transportation services, crisis stabilization, individualized residential alternative (IRA) residential habilitation or community residential habilitation, respite services, transition services, youth psychiatry services, therapeutic family care or foster care, mental health services, services coordination, succession services, discharge or step-down services, prioritized admission, and wrap-around services.
